(19) United States
(12) Patent Application Publication
(10) Pub. No.: US 2008/0098554 A1
(43) Pub. Date: May 1, 2008

(54) WIPER BLADE ASSEMBLY

(75) Inventor: Kyung-Hee CHO, Nam-gu (KR)

Correspondence Address: OBLON, SPIVAK, MCCLELLAND MAIER & NEUSTADT, P.C., 1940 DUKE STREET, ALEXANDRIA, VA, 22314, US

(73) Assignee: KWC CORPORATION, Dalseo-gu (KR)

(21) Appl. No.: 11/760,357

(22) Filed: Jun. 8, 2007

(30) Foreign Application Priority Data
Oct. 25, 2006 (KR) 10-2006-0103802

(51) Int. Cl. B60S 1/40

(52) U.S. Cl. 15/250.32

(57) ABSTRACT

Disclosed herein is a wiper blade assembly which is connected to an automobile wiper arm by means of a connector while coming into close contact with the glass surface of an automobile windshield. The wiper blade assembly includes a flexible blade, an elastic member, and a spoiler. The wiper blade assembly has the effect of reducing the number of constituent elements and achieving the easy assembling operation of the elements by virtue of a simplified configuration thereof.

### BACKGROUND OF THE INVENTION

1. Field of the Invention

The present invention relates to a wiper blade assembly which is connected to an automobile wiper arm via a connector and configured to come into close contact with the glass surface of an automobile windshield, and, more particularly, to a wiper blade assembly which has a simplified configuration capable of reducing the number of constituent elements and enabling the easy assembling operation of the constituent elements.

2. Description of the Related Art

A wiper has a function of removing impurities on the glass surface of an automobile windshield while coming into close contact with the curved glass surface. To guarantee the close contact between the wiper and the curved glass surface, there are employed several methods, for example, a method for uniformly distributing a press pressure force applied by a wiper arm to a wiper blade, and a method for providing a wiper blade assembly originally having a curvature.

A wiper, using the latter method for imparting the wiper blade assembly with a curvature suitable to come into contact with the glass surface, is called a flat wiper. The present invention deals with a flat wiper blade assembly. As will be expected, the wiper blade assembly, originally having the curvature, also has elasticity. Therefore, the flexible and elastic wiper blade assembly has no problem of coming into close contact with the glass surface even if there is no separate structure for distributing the load of the wiper arm and consequently, has an advantage of achieving a simplified configuration.

FIG. 1 illustrates an example of the above described kind of conventional flat wiper blade assembly. The illustrated conventional flat wiper blade assembly generally comprises: a flexible wiper blade 14 to come into elastic contact with the glass surface of an automobile windshield; a rail spring 15 to maintain the shape of the wiper blade 14; an elastic member 12 to transfer the load of a wiper arm (not shown) to both the wiper blade 14 and the rail spring 15; yoke clips 13 to couple the elastic member 12 to the rail spring 15 and the wiper blade 14; and a wiper connector 11 to connect the wiper blade assembly to the wiper arm (not shown). The conventional flat wiper blade assembly further comprises caps 16 to prevent separation of the rail spring 15.

Although not shown, to increase the contact efficiency of the wiper blade assembly, the conventional wiper blade assembly further comprises a spoiler. In conclusion, the conventional wiper blade assembly has a significantly complicated configuration and suffers from the enormous number of constituent elements. For this reason, there are some problems in that a variety of constituent elements should be made in the course of fabricating the wiper blade assembly and the resulting wiper blade assembly has a need for a troublesome assembling operation of the constituent elements.

### SUMMARY OF THE INVENTION

Therefore, the present invention has been made in view of the above problems of the conventional wiper blade assembly, and it is an object of the present invention to provide a wiper blade assembly of a simplified configuration consisting of a wiper blade, elastic member, and spoiler without requiring a rail spring, yoke clips, and caps, thereby achieving a reduction in the number of constituent elements and consequently, the easy assembling operation of the constituent elements.

In accordance with one aspect of the present invention, the above and other objects can be accomplished by the provision of a wiper blade assembly to be connected to an automobile wiper arm by means of a connector while coming into contact with the glass surface of an automobile windshield, the wiper blade assembly comprising: a flexible blade including a blade edge, a receiving groove formed in a side surface thereof to extend along a longitudinal direction of the blade, and separation-preventing stepped portions formed at both longitudinal ends of the receiving groove; an elastic member originally having a predetermined curvature and configured to extend the longitudinal direction of the blade, the elastic member including a coupling portion to be received into the receiving groove of the flexible blade and a surplus portion not to be received in the receiving groove, the surplus portion having spoiler fitting holes; and a spoiler including protrusions to be fitted into the fitting holes of the elastic member, and a guiding/receiving structure to guide the insertion of the elastic member so as to receive the surplus portion of the elastic member.

In accordance with another aspect of the present invention, the above and other objects can be accomplished by the provision of a wiper blade assembly comprising: a flexible blade including a blade edge formed at a lower surface thereof, two receiving grooves formed in opposite side surfaces thereof to extend along a longitudinal direction of the blade, and separation-preventing stepped portions formed at both longitudinal ends of each receiving groove; two elastic members originally having a predetermined curvature and configured to extend the longitudinal direction of the blade, each elastic member including a coupling portion to be received into the associated receiving groove of the flexible blade and a surplus portion not to be received in the receiving groove, the surplus portion having spoiler fitting holes; and a spoiler including protrusions to be fitted into the fitting holes of the elastic member, and two guiding/receiving structures to guide the insertion of the two elastic members so as to receive the surplus portions of the elastic members, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a side view of a conventional wiper blade assembly;

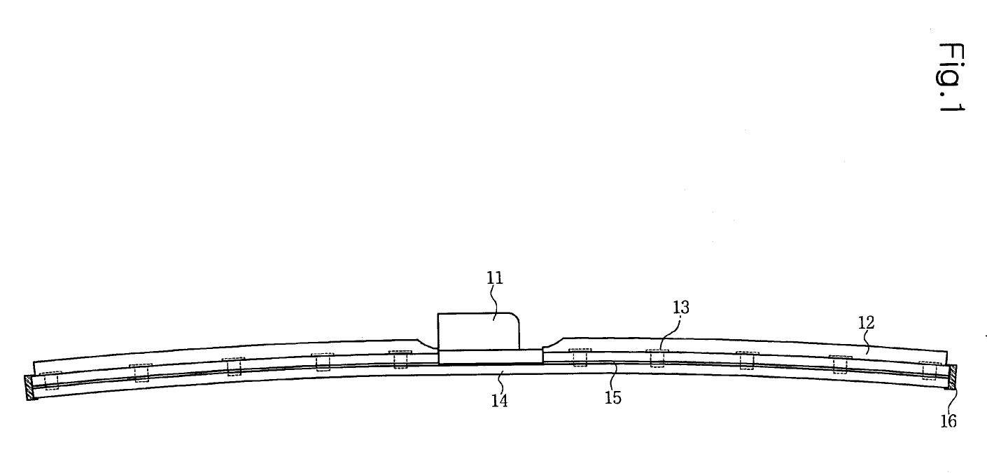

FIG. 2 is an exploded perspective view of a wiper blade assembly according to the present invention;

FIG. 3 is a perspective view of the completed wiper blade assembly according to the present invention;

FIG. 4 is a perspective view illustrating the cross section of the wiper blade assembly of FIG. 3;

FIG. 5 is a side sectional view of the completed wiper blade assembly of FIG. 3; and

FIG. 6 is a rear view of the completed wiper blade assembly of FIG. 3.

### DETAILED DESCRIPTION OF THE PREFERRED EMBODIMENTS

Now, preferred embodiments of the present invention will be described with reference to the accompanying drawings.

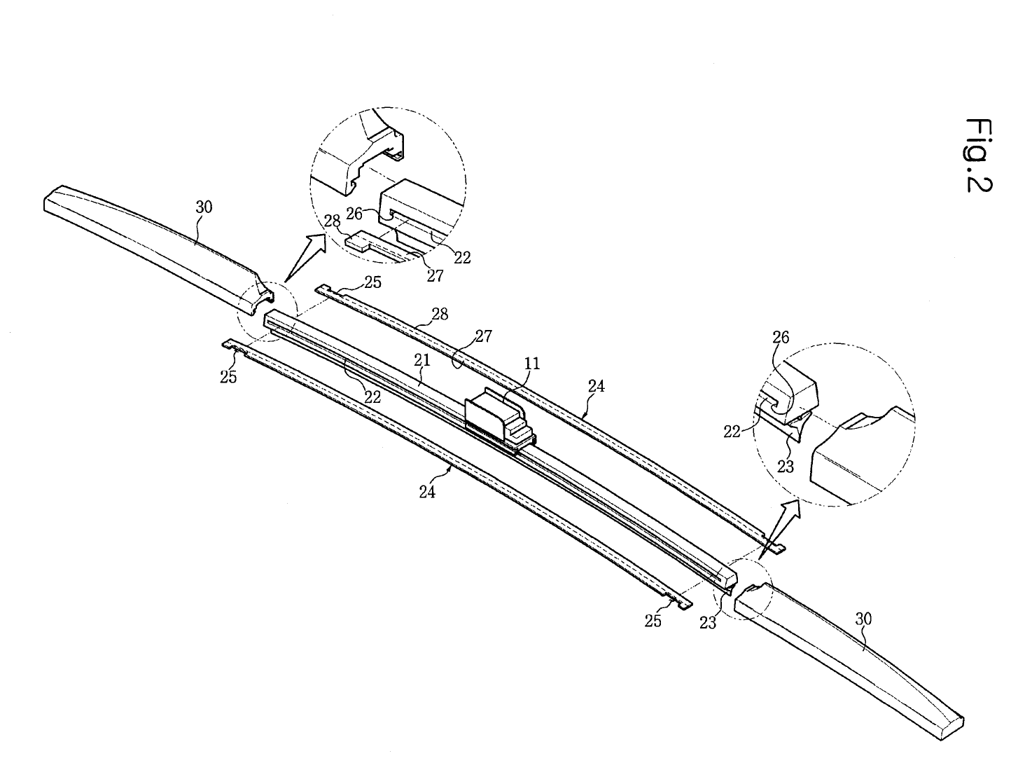

FIG. 2 is an exploded perspective view illustrating the coupling relationship of a flexible wiper blade and elastic members included in a wiper blade assembly according to an embodiment of the present invention.

As shown in FIG. 2, the flexible wiper blade 21 of the wiper blade assembly includes: a blade edge 23; at least one receiving groove 22; and separation-preventing stepped portions 26. The blade 21 has a function of removing impurities on the glass surface of an automobile windshield while coming into close contact with the glass surface. The blade 21 has a flexibility sufficient to easily come into close contact with the glass surface. Generally, the flexible blade 21 is made of rubber.

The blade edge 23 is mounted to a lower surface of the wiper blade 21 and has an end to come into close contact with the glass surface. Accordingly, the blade edge 23 is actually used to remove impurities on the glass surface.

The receiving groove 22 is formed in a side surface of the blade 21 along a longitudinal direction of the blade 21. The size of the receiving groove 22 is determined such that it receives the elastic member 24 therein. In a preferred embodiment, a pair of receiving grooves 22 are formed in left and right side surfaces of the blade 21, respectively, such that a pair of elastic members can support the blade 21 at left and right sides of the blade 21.

Preferably, the receiving groove 22 of the blade 21 has a width slightly smaller than a thickness of the elastic member 24. The blade 21, which is made of rubber, has elasticity. Therefore, even if the elastic member 24 has a thickness larger than the width of the receiving groove 22, the elastic member 24 can be sufficiently received in the receiving groove 22 of the blade 21, and has no risk of being unintentionally separated from the receiving groove 22.

The separation-preventing stepped portions 26 are illustrated in the partially enlarged parts of FIG. 2. The separation-preventing stepped portions 26 are formed at both longitudinal ends of the blade 21 and have a function of preventing the elastic member 24 from being separated from the receiving groove 22.

If there is no separation-preventing stepped portions 26, the elastic member 24 may be separated in a longitudinal direction of the blade 21 when being unintentionally slipped in the receiving groove 22. Accordingly, the separation-preventing stepped portions 26 serve to stably secure the elastic member 24 in the blade 21.

With the provision of the separation-preventing stepped portions 26, the present embodiment has the effect of more surely preventing the separation of the elastic member 24 without wiper caps that have been essentially used in a conventional wiper blade assembly.

The elastic member 24 has a function of maintaining the shape of the blade 21 in consideration of the fact that the blade is made of a flexible material such as rubber and thus, has a difficulty to maintain its original shape. Another function of the elastic member 24 is to transfer the load of a wiper arm to the blade 21. The elastic member 24 includes: fitting holes 25; a coupling portion 27; and a surplus portion 28. The elastic member 24 is generally made of an elastic metal.

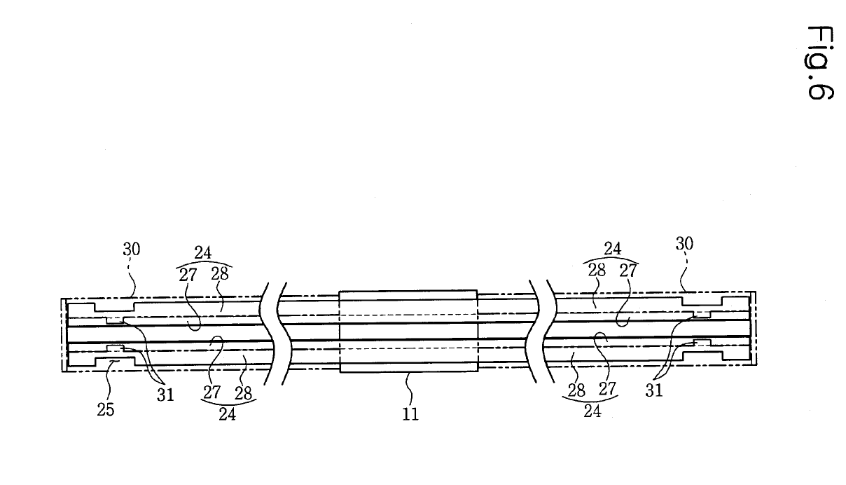

As shown in FIG. 6, each fitting hole 25 is perforated in a side surface of the elastic member 24 and used to securely fix the elastic member 24 to the spoiler 30. The fitting hole 25 may be formed by simply cutting a part of the elastic member 24. Preferably, the fitting hole 25 is perforated in the surplus portion 28 of the elastic member 24 at a position suitable for the fitting of the spoiler 30.

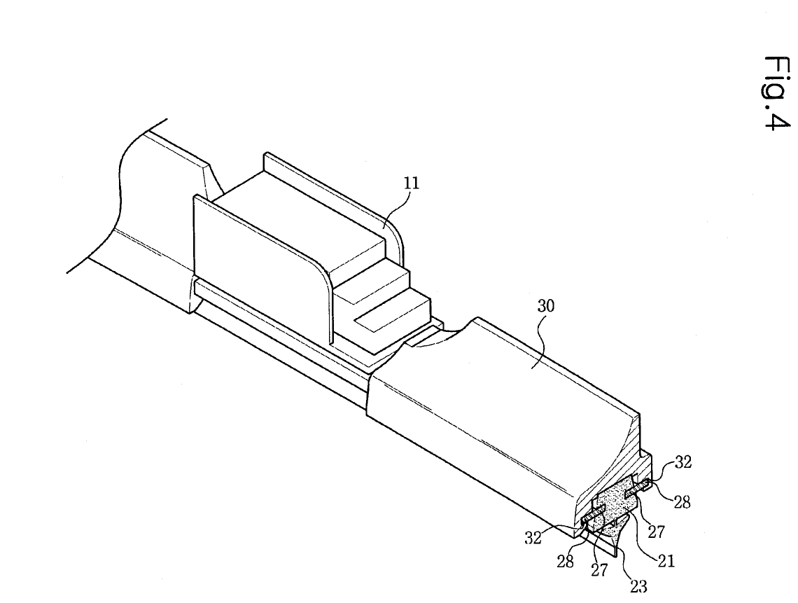

As shown in FIGS. 4, 5, and 6, the coupling portion 27 is a part of the elastic member 24 to be received into the receiving groove 22. The surplus portion 28 is the remaining part of the elastic member 24 not to be received in the receiving groove 22. In the present embodiment, the coupling portion 27 and the surplus portion 28 are integrally formed with each other, and for the sake of simplicity, are considered as one part to be received into the receiving groove 22 and the other part not to be received in the receiving groove 22.

Preferably, the elastic member 24 has a length longer than the inner longitudinal length of a receiving space that is defined by the receiving groove 22 and the separation-preventing stepped portions 26. That is to say, the length of the coupling portion 27 of the elastic member 24, to be received into the receiving groove 22, is longer than a distance between the separation-preventing stepped portions 26 formed at both the longitudinal ends of the receiving groove 22.

With the above described configuration, when the elastic member 24 is fitted into the receiving groove 22 of the blade 21, the flexible blade 21 is further extendible on the nature of flexibility thereof so as to enclose the elastic member 24. As a result, the elastic member 24 can be strongly coupled to the blade 21.

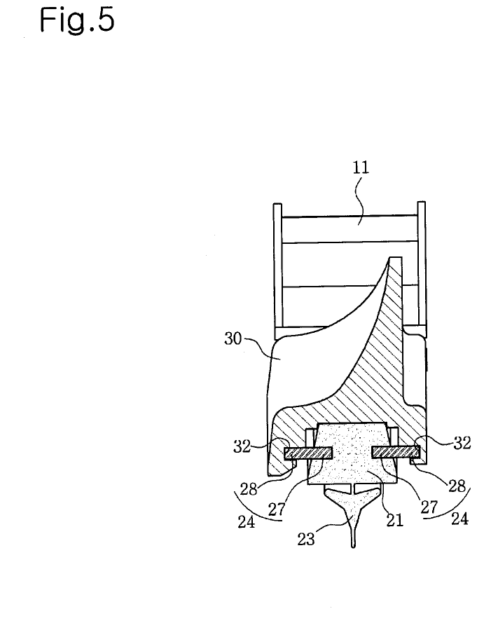

The spoiler 30, as shown in FIGS. 4 and 5, has an inclined upper surface, and has a function of preventing lifting of the wiper blade assembly during automobile traveling. The spoiler 30 includes protrusions 31, and at least one guiding/receiving structure 32.

The protrusions 31, as shown in FIG. 6, are formed at either inner side surface of the spoiler 30, and configured to have a female-male coupling with the fitting holes 25 perforated in the surplus portion 28 of the elastic member 24. Thereby, the protrusions 31 serve to prevent relative movements between the spoiler 30 and the elastic member 24.

The guiding/receiving structure 32, as shown in FIGS. 4 and 5, takes the form of a rail formed at either inner side surfaces of the spoiler 30. The guiding/receiving structure 32 is capable of guiding and receiving the surplus portions 28 of the elastic member 24. Here, the reason why the structure 32 is called “guiding/receiving structure” is that the elastic member 24 can be inserted into the spoiler 30 along the rail-shaped guiding/receiving structure 32.

The guiding/receiving structure 32 is configured to receive the surplus portion 28 so as to enclose the elastic member 24 as shown in FIGS. 4 and 5. In this way, the elastic member 24 can be coupled to the spoiler 30 and consequently, the blade 21, which was previously coupled to the elastic member 24, can be coupled to the spoiler 30.

In consideration of the fact that the wiper connector 11 has to be coupled to the elastic member 24, the spoiler 30 may have an integral configuration or a dividable configuration as occasion demands. When the spoiler 30 has an integral configuration, the spoiler 30 is perforated with a through-hole at the center of a longitudinal direction thereof such that the wiper connector 11 is coupled to the elastic member 24 by penetrating through the spoiler 30. On the other hand, when the spoiler 30 has a dividable configuration, the spoiler 30 is divided into two left and right parts on the basis of the coupling location of the wiper connector 11.

Now, the coupling relationship and operation of the present embodiment will be described with reference to the accompanying drawings.

To couple the elastic member 24 to the flexible blade 21 as shown in FIG. 2, the elastic member 24 is inserted into the receiving groove 22 of the blade 21. In this case, since the longitudinal length of the receiving groove 22 between the separation-preventing stepped portions 26 is shorter than the length of the elastic member 24, the insertion of the elastic member 24 is performed by stretching the blade 21 in a longitudinal direction thereof so as to elastically increase the length of the receiving groove 22 by a length sufficient for the insertion of the elastic member 24. Then, if a stretching force of the blade 21 is removed, the elastic member 24 can be elastically caught by the separation-preventing stepped portions 26 and securely received in the receiving groove 22.

After completion of the above described coupling operation, only the coupling portion 27 of the elastic member 24 is received into the receiving groove 22 and the surplus portion 28 of the elastic member 24 is protruded out of the blade 21. The surplus portion 28, protruded out of the blade 21, is then inserted into and guided along the guiding/receiving structure 32 of the spoiler 30 such that the surplus portion 28 can be seated and received in the inner side surface of the spoiler 30 as shown in FIG. 6.

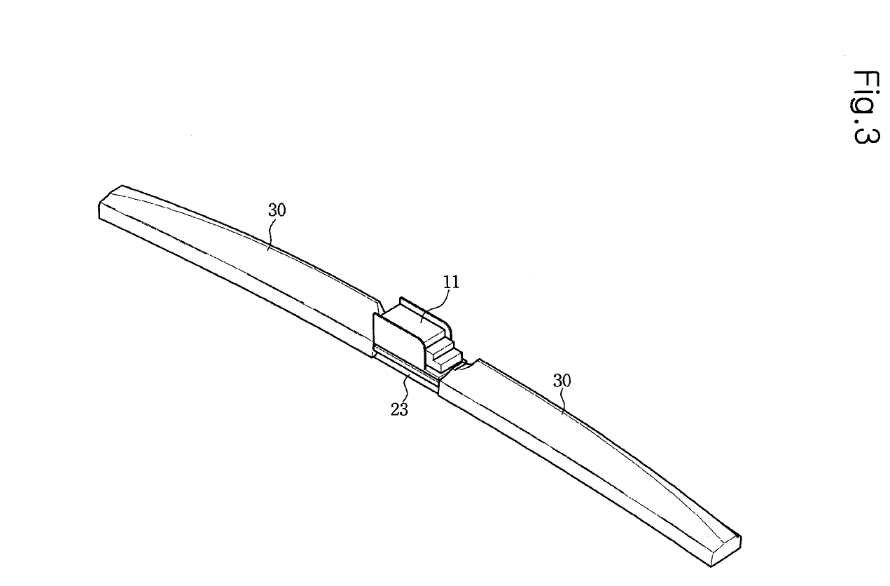

If the fitting holes 25 included in the surplus portion 28 have a female-male coupling with the protrusions 31 of the spoiler 30, as shown in FIG. 3, the elastic member 24 and the spoiler 30 are stably coupled to each other without the risk of relative movements. Consequently, the blade 21, which was previously coupled to the elastic member 24, is stably coupled to the spoiler 30.

The resulting wiper blade assembly will be coupled to a wiper arm (not shown) by use of the wiper connector 11 such that the load of the wiper arm is transferred to the elastic member 24 through the wiper connector 11. Accordingly, the elastic member 24 acts to push the blade 21 upon receiving the load of the wiper arm, thereby allowing the blade 21 to come into close contact with the glass surface of an automobile windshield.

As apparent from the above description, the present invention provides a wiper blade assembly having a simplified configuration requiring no rail spring, yoke clips, wiper caps, etc. which have been essentially used in a conventional wiper blade assembly. Instead of using the above mentioned elements, in the wiper blade assembly of the present invention, a pair of elastic members are coupled to the blade such that a part of each elastic member protrudes out of the blade, and a spoiler is coupled to the elastic members.

With the above described simplified configuration, the wiper blade assembly of the present invention can achieve a reduction in the number of overall constituent elements and guarantee the easy fabrication and assembling operation of the elements.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wiper blade assembly to be connected to an automobile wiper arm by means of a connector while coming into contact with the glass surface of an automobile windshield, the wiper blade assembly comprising:
a flexible blade including a blade edge, a receiving groove formed in a side surface thereof to extend along a longitudinal direction of the blade, and separation-preventing stepped portions formed at both longitudinal ends of the receiving groove;
an elastic member originally having a predetermined curvature and configured to extend the longitudinal direction of the blade, the elastic member including a coupling portion to be received into the receiving groove of the flexible blade and a surplus portion not to be received in the receiving groove, the surplus portion having spoiler fitting holes; and
a spoiler including protrusions to be fitted into the fitting holes of the elastic member, and a guiding/receiving structure to guide the insertion of the elastic member so as to receive the surplus portion of the elastic member.

2. The wiper blade assembly according to claim 1, wherein the elastic member has a length longer than an inner longitudinal length of a receiving space defined by the associated receiving groove and the separation-preventing stepped portions of the receiving groove.

3. A wiper blade assembly to be connected to an automobile wiper arm by means of a connector while coming into contact with the glass surface of an automobile windshield, the wiper blade assembly comprising:
a flexible blade including a blade edge formed at a lower surface thereof, two receiving grooves formed in opposite side surfaces thereof to extend along a longitudinal direction of the blade, and separation-preventing stepped portions formed at both longitudinal ends of each receiving groove;
two elastic members originally having a predetermined curvature and configured to extend the longitudinal direction of the blade, each elastic member including a coupling portion to be received into the associated receiving groove of the flexible blade and a surplus portion not to be received in the receiving groove, the surplus portion having spoiler fitting holes; and
a spoiler including protrusions to be fitted into the fitting holes of the elastic member, and two guiding/receiving structures to guide the insertion of the two elastic members so as to receive the surplus portions of the elastic members, respectively.

4. The wiper blade assembly according to claim 3, wherein the elastic member has a length longer than an inner longitudinal length of a receiving space defined by the associated receiving groove and the separation-preventing stepped portions of the receiving groove.

5. A wiper blade assembly to be connected to an automobile wiper arm by means of a connector while coming into contact with the glass surface of an automobile windshield, comprising:
a flexible blade including a blade edge, a receiving groove formed in a side surface thereof to extend along a longitudinal direction of the blade, and separation-preventing stepped portions formed at both longitudinal ends of the receiving groove;
an elastic member originally having a predetermined curvature and configured to extend the longitudinal direction of the blade, the elastic member including a coupling portion to be received into the receiving groove of the flexible blade and a surplus portion not to be received in the receiving groove, the surplus portion having spoiler fitting holes; and
a spoiler including protrusions to be fitted into the fitting holes of the elastic member, and a guiding/receiving structure to guide the insertion of the elastic member so as to receive the surplus portion of the elastic member,
wherein the spoiler is longitudinally divided into two parts on the basis of the connector.

6. The wiper blade assembly according to claim 5, wherein the elastic member has a length longer than an inner longitudinal length of a receiving space defined by the receiving groove and the separation-preventing stepped portions of the receiving groove.
